(19) United States
(12) Patent Application Publication
(10) Pub. No.: US 2002/0065913 A1
(43) Pub. Date: May 30, 2002

(54) Network password reset system

(76) Inventor: Gregory Lee Harrington, Pflugerville, TX (US)

Correspondence Address: Robert V. Wilder, Attorney at Law, 4235 Kingsburg Drive, Round Rock, TX, 78681, US

(21) Appl. No.: 09/726,012

(22) Filed: Nov. 29, 2000

(51) Int. Cl. G06F 15/173; G06F 12/14; H04L 9/32

(52) U.S. Cl. 709/225; 713/200

(57) ABSTRACT

A method and implementing system are provided in which, a web based password reset tool includes means for resetting passwords for OS/2 user IDs. In an illustrated example, an OS/2 environment is contacted using TCP/IP over NetBIOS (TCPBEUI). NetBIOS packets are passed through routers into the NetBIOS network. The user ID and new passwords are issued and passed to the OS/2 server to be set. After the OS/2 server sets the password, the new password will be sent back to the password reset tool for access and/or display to the user requesting the new password. The new password is displayed through an email message or using another application display area.

### FIELD OF THE INVENTION

The present invention relates generally to information processing systems and more particularly to a methodology and implementation for resetting passwords in distributed network systems.

### BACKGROUND OF THE INVENTION

The continually increasing use and development of networks, including the Internet as well as local area networks (LANs), has created a massive communication system in which any one computer machine or system is able to communicate with almost any other machine in any country of the world. The term “machine” as used herein refers to computer systems which may be operating as user terminals or network servers. The evolution of networks and computer systems has also created an environment in which many different operating systems and computer machines exist and each machine needs to be able to have access to other machines which in many cases have different operating systems. Moreover, each different operating system will have application programs created to work specifically with that particular operating system. Programs written to operate with one operating system may not have corresponding programs written to operate on different operating systems.

Through the use of inter-connected networked systems, users on one system are able to have access to and utilize resources which are available on machines located elsewhere in the network. Such systems however, require relatively intricate security routines to insure that only authorized users have access to available network resources. The security and access functions are provided through the use of special access programs, including web-based password reset tools, to manage user ID and password processing and access to network resources at local and remote network sites.

However, current web-based password reset tools can only be installed on certain operating systems. For example, an existing version of “HelpNow! EasyAccess 2.0™” (HNEA) can only be installed on a server running Microsoft Windows NT 4.0™, and the server clients are only clients running Windows 95™, Windows 98™, Windows NT™ and Windows 2000™ operating systems. HNEA operates as web-based password reset tool to reset the passwords of user IDs that are created in Windows NT and Windows 2000, HPUX™, AIX™, Sun Solaris™, MVS™ and Novell Netware™ systems. Even though the end user must have a user ID to log on to the HNEA application, the user ID of each networking environment already exists independently of the HNEA application. Only the user ID of the HNEA application is created from HNEA. The other user IDs are created in their own respective environments. For example, the user ID of an AIX environment must be created on AIX, not HNEA.

Thus, there is a need for an improved web based password reset tool that is capable of resetting passwords for user IDs created in OS/2 systems.

### SUMMARY OF THE INVENTION

A method and implementing system are provided in which, in an exemplary embodiment, a web based password reset tool includes means for resetting passwords for OS/2 user IDs. In the illustrated example, an OS/2 environment is contacted using TCP/IP (Transport Control Protocol) over NetBIOS (Network Basic Input Output System). NetBIOS packets are passed through routers into the NetBIOS network. The user ID and new passwords are issued and passed to the OS/2 server to be set. After the OS/2 server sets the password, the new password will be sent back to the password reset tool for access and/or display to the user requesting the new password.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of an exemplary network system;

FIG. 2 is a schematic diagram of an exemplary computer system; and

FIG. 3 is a flowchart illustrating an exemplary methodology implemented in one embodiment of the present invention;

### DETAILED DESCRIPTION

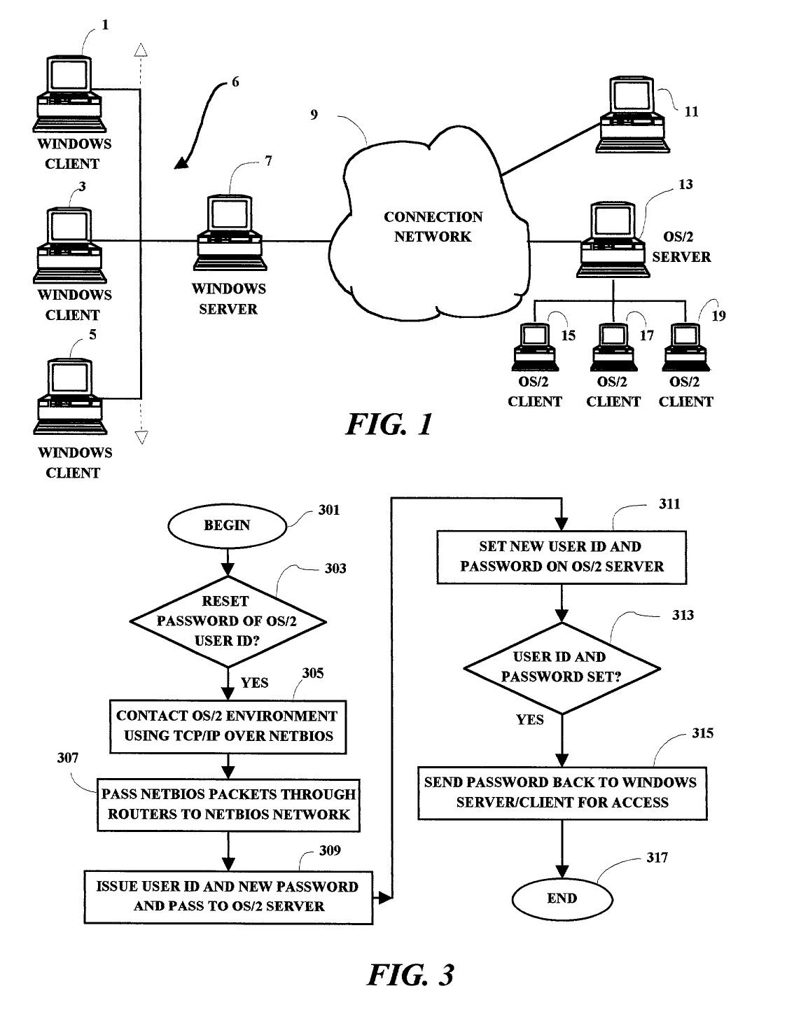

The various methods discussed herein may be implemented within an exemplary distributed information processing system as illustrated in FIG. 1. As shown, an exemplary information processing system includes first, second and third computer machines 1, 3 and 5, which are connected together in a first network configuration 6 and coupled to a network server 7. The network server 7 is, in turn, connected through a connection network 9, to one or more remote computer systems 11 and 13. Computer systems 11 and 13 may, for example, be servers at remote network sites and the connection network 9 may be the Internet. In the example, the server 13 is an OS/2 system and is connected to OS/2 client or user terminals 15, 17 and 19. In the illustrated example, server 7 is operating a Windows operating system and client or user terminals 1, 3 and 5 are also running Windows systems.

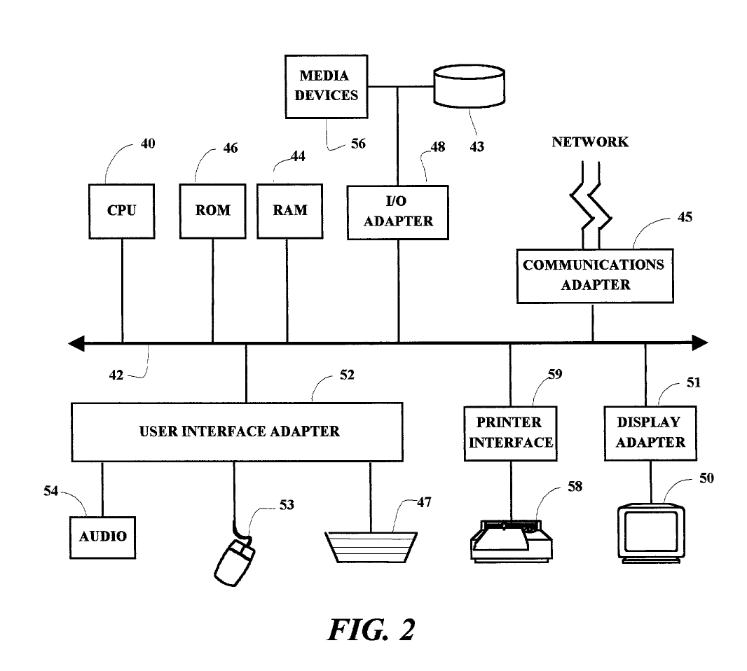

Referring to FIG. 2, there is shown a pictorial representation of an exemplary server computer system or workstation having a central processing unit (CPU) 40 such as a conventional microprocessor, and a number of other units interconnected via a system bus 42. The exemplary workstation shown in FIG. 2 further includes a Random Access Memory (RAM) 44, a Read-Only Memory (ROM) 46, an input/output (I/O) adapter 48 for connecting peripheral devices such as storage unit 43 and one or more media devices 56 (such as floppy disks and CDs) to the bus 42. A user interface adapter 52 is shown connecting a keyboard 47, a mouse 53 and an audio system 54 (which may include speakers and microphones) to the bus 42. Other devices may also be connected to the bus 42 through the user interface adapter 52. A communications adapter 45 is shown in the example connecting the bus 42 to one or more networks, and a display adapter 51 connects a display device 50 to the main bus 42. The computer software embodiment of the present invention may be included as software installed on one of the workstations within the distributed environment illustrated. One skilled in the art will appreciate that the procedures associated with the present invention may be in the form of a computer program product on a computer readable medium, which may be temporarily or permanently loaded on the illustrated workstation from media devices 56 such as CD or floppy diskettes, and also from storage devices such as hard drive 43, and executed from RAM memory 44.

In FIG. 3, there is shown a flowchart illustrating an exemplary embodiment of the methodology of the present invention. In the example, HNEA is installed on the Windows server 7 as shown in FIG. 1. Code is included in HNEA to add the capability for HNEA to be able to reset the password of an OS/2 user ID. This is accomplished by creating a file that will contact the server 13 of the OS/2 environment. To contact the OS/2 environment 301, when it is desired to reset the password of an OS/2 user ID 303, the OS/2 server 13 is contacted using TCP/IP over NetBIOS 305. This will allow using TCP/IP to pass NetBIOS packets through routers (not shown) into the NetBIOS network 307. The packets contain the administrative ID and password of the OS/2 environment and the user ID and the new password of that user ID. The administrative ID and password are necessary to contact the server with privileges that allow the administrative ID to reset passwords of other users of the OS/2 network. The user ID and new password are then issued and passed to the OS/2 server 13 to be set 309. The new user ID and new password are then set 311 and after being set 313, the password is then sent back 315 to the HNEA application on Windows server 7 for client access 315 and the process ends 317. The new password is then displayed through an email message or through the user screen display.

The method and apparatus of the present invention has been described in connection with a preferred embodiment as disclosed herein. The disclosed methodology may be implemented in many different ways in order to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may be implemented partially or totally in program code stored on one of many possible media carriers, or other memory device, from which it may be accessed and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for enabling a reset of a password for an OS/2 user ID within an OS/2 environment from a Windows server within a Windows environment, said method comprising:
contacting an OS/2 server for said OS/2 environment;
issuing a new password by said Windows server;
passing said new password from said Windows server to said OS/2 server;
setting said new password by said OS/2 server; and
returning said new password from said OS/2 server to said Windows server.

2. The method as set forth in claim 1 and further including displaying said new password on a display device in said Windows environment.

3. The method as set forth in claim 1 wherein said returning is accomplished by sending an email to said Windows server.

4. The method as set forth in claim 1 wherein said passing is accomplished using TCP/IP.

5. The method as set forth in claim 4 wherein said passing is accomplished by passing NetBIOS packets to said OS/2 server.

6. The method as set forth in claim 5 wherein said NetBIOS packets are passed through routers to said OS/2 server.

7. The method as set forth in claim 6 and further including displaying said new password on a display device in said Windows environment.

8. The method as set forth in claim 6 wherein said returning is accomplished by sending an email to said Windows server.

9. A storage medium including machine readable coded indicia, said storage medium being selectively coupled to a reading device, said reading device being selectively coupled to processing circuitry, said reading device being selectively operable to read said machine readable coded indicia and provide program signals representative thereof, said program signals being effective for enabling a reset of a password for an OS/2 user ID within an OS/2 environment from a Windows server within a Windows environment, said program signals being selectively operable to accomplish the steps of:
contacting an OS/2 server for said OS/2 environment;
issuing a new password by said Windows server;
passing said new password from said Windows server to said OS/2 server;
setting said new password by said OS/2 server; and
returning said new password from said OS/2 server to said Windows server.

10. The medium as set forth in claim 9 wherein said program signals are further effective to cause a displaying said new password on a display device in said Windows environment.

11. The medium as set forth in claim 9 wherein said returning is accomplished by sending an email to said Windows server.

12. The medium as set forth in claim 9 wherein said passing is accomplished using TCP/IP.

13. The medium as set forth in claim 12 wherein said passing is accomplished by passing NetBIOS packets to said OS/2 server.

14. The medium as set forth in claim 13 wherein said NetBIOS packets are passed through routers to said OS/2 server.

15. The medium as set forth in claim 14 wherein said program signals are further effective to cause a displaying said new password on a display device in said Windows environment.

16. The medium as set forth in claim 14 wherein said returning is accomplished by sending an email to said Windows server.

17. A network information processing system comprising:
a Windows server device operating in a Windows environment;
an OS/2 server device operating in an OS/2 environment; and
means selectively operable for connecting said Windows server with said OS/2 server, said network information processing system being selectively operable for issuing a new password by said Windows server and contacting said OS/2 server by said Windows server, said network information processing system being operable for passing said new password from said Windows server to said OS/2 server, said OS/2 server being operable to set said new password and return an acknowledgement of said new password from said OS/2 server to said Windows server.
